(19) United States
(12) Patent Application Publication
(10) Pub. No.: US 2014/0004435 A1
(43) Pub. Date: Jan. 2, 2014

(54) PHOTOELECTRODE AND METHOD FOR PRODUCING SAME, PHOTOELECTROCHEMICAL CELL AND ENERGY SYSTEM USING SAME, AND HYDROGEN GENERATION METHOD

(71) Applicants: Satoru Tamura, Osaka (JP); Takaiki Nomura, Osaka (JP); Takahiro Suzuki, Osaka (JP); Kenichi Tokuhiro, Osaka (JP); Noboru Taniguchi, Osaka (JP); Kazuhito Hato, Osaka (JP); Nobuhiro Miyata, Osaka (JP)

(72) Inventors: Satoru Tamura, Osaka (JP); Takaiki Nomura, Osaka (JP); Takahiro Suzuki, Osaka (JP); Kenichi Tokuhiro, Osaka (JP); Noboru Taniguchi, Osaka (JP); Kazuhito Hato, Osaka (JP); Nobuhiro Miyata, Osaka (JP)

(73) Assignee: PANASONIC CORPORATION, Kadoma-shi, Osaka (JP)

(21) Appl. No.: 14/005,156

(22) PCT Filed: Apr. 25, 2012
(86) PCT No.: PCT/JP2012/002843

§ 371 Date: Sep. 13, 2013

(30) Foreign Application Priority Data
Jun. 15, 2011 (JP) 2011-109830

(51) Int. Cl. C25B 11/04; C25B 1/00; H01M 8/06

(52) U.S. Cl. CPC C25B 11/0405; H01M 8/0656; C25B 1/003
USPC 429/422; 204/290.01; 204/290.13; 204/242; 205/340; 264/104

(57) ABSTRACT

A photoelectrode (100) of the present invention includes a conductive layer (12) and a photocatalytic layer (13) provided on the conductive layer (12). The conductive layer (12) is made of a metal nitride. The photocatalytic layer (13) is made of at least one selected from the group consisting of a nitride semiconductor and an oxynitride semiconductor. When the photocatalytic layer (13) is made of a n-type semiconductor, the energy difference between the vacuum level and the Fermi level of the conductive layer (12) is smaller than the energy difference between the vacuum level and the Fermi level of the photocatalytic layer (13).

When the photocatalytic layer (13) is made of a p-type semiconductor, the energy difference between the vacuum level and the Fermi level of the conductive layer (12) is larger than the energy difference between the vacuum level and the Fermi level of the photocatalytic layer (13).

### TECHNICAL FIELD

The present invention relates to a photoelectrode including a photocatalyst capable of decomposing water by being irradiated with light, a method for producing the photoelectrode, a photoelectrochemical cell, an energy system using the photoelectrochemical cell, and a hydrogen generation method.

### BACKGROUND ART

A photoelectrode used for generating hydrogen by water decomposition has a configuration in which a photocatalytic film is supported on a conductive substrate. This is in order to allow efficient charge separation between electrons and holes generated in the photocatalytic film.

For example, Non-Patent Literature 1 discloses a photoelectrode in which the photocatalytic film used is a film made of an oxynitride semiconductor (TaON) and the conductive substrate used is a substrate having a configuration in which FTO (Fluorine doped Tin Oxide) which is a transparent conductive film is provided on a glass substrate. The processes for producing the photoelectrode are as follows. First, fine particles of TaON are electrodeposited on the FTO of the conductive substrate. Next, in order to improve crystallinity and necking (necking between the FTO and the TaON particles, and necking between the TaON particles themselves), TaCl₅ is dropped onto and calcined on the substrate to which the TaON particles have been attached, and then the resultant substrate is heated in a flow of ammonia gas (nitriding treatment is carried out). By these processes, a photoelectrode having a multilayer structure of TaON/FTO/glass is fabricated.

In addition, Non-Patent Literature 2 discloses a photoelectrode in which the photocatalytic film used is a film made of a nitride semiconductor (Ta₃N₅), and the conductive substrate used is a Ta metal substrate. The processes for producing the photoelectrode are as follows. First, the Ta metal substrate is burned in air to form a Ta oxide film on the surface of the substrate. Next, the Ta metal substrate on the surface of which the Ta oxide film has been formed is heated in a flow of ammonia gas to nitride the Ta oxide film. By these processes, a photoelectrode having a multilayer structure of Ta₃N₅/Ta metal is fabricated.

### CITATION LIST

### Non Patent Literature

Non-Patent Literature 1: J. AM. CHEM. SOC. 2010, 132, 11828-11829

Non-Patent Literature 2: J. Phys. Chem. B 2004, 108, 11049-11053

### SUMMARY OF INVENTION

### Technical Problem

However, it has been difficult to achieve high catalytic activity in the photoelectrodes provided by the above conventional production processes.

Accordingly, in order to solve the conventional problem, the present invention aims to provide a photoelectrode having high catalytic activity.

### Solution to Problem

The present invention provides a photoelectrode including a conductive layer and a photocatalytic layer provided on the conductive layer. The conductive layer is made of a metal nitride, and the photocatalytic layer is made of at least one selected from the group consisting of a nitride semiconductor and an oxynitride semiconductor. When the photocatalytic layer is made of a n-type semiconductor, an energy difference between a vacuum level and a Fermi level of the conductive layer is smaller than an energy difference between the vacuum level and a Fermi level of the photocatalytic layer. When the photocatalytic layer is made of a p-type semiconductor, an energy difference between the vacuum level and a Fermi level of the conductive layer is larger than an energy difference between the vacuum level and a Fermi level of the photocatalytic layer.

### Advantageous Effects of Invention

The photoelectrode of the present invention can be constituted by both a conductive layer having a low resistance value and a photocatalytic layer having high catalytic activity and high crystallinity, and can consequently exhibit high catalytic activity.

### BRIEF DESCRIPTION OF DRAWINGS

FIG. 1 is a cross-sectional view showing a configuration of a photoelectrode of an embodiment 1 of the present invention.

FIG. 2A is a schematic diagram showing a band structure observed before junction between a conductive layer and a photocatalytic layer of the photoelectrode of the embodiment 1 of the present invention in the case where the photocatalytic layer is made of a n-type semiconductor, and FIG. 2B is a schematic diagram showing a band structure observed after junction between the conductive layer and the photocatalytic layer of the photoelectrode of the embodiment 1 of the present invention in the case where the photocatalytic layer is made of a n-type semiconductor.

FIG. 3A is a schematic diagram showing a band structure observed before junction between a conductive layer and a photocatalytic layer of the photoelectrode of the embodiment 1 of the present invention in the case where the photocatalytic layer is made of a p-type semiconductor, and FIG. 3B is a schematic diagram showing a band structure observed after junction between the conductive layer and the photocatalytic layer of the photoelectrode of the embodiment 1 of the present invention in the case where the photocatalytic layer is made of a p-type semiconductor.

FIG. 4 is a schematic diagram showing a configuration of a photoelectrochemical cell of an embodiment 2 of the present invention.

FIG. 5 is a diagram showing a state of the photoelectrochemical cell of the embodiment 2 of the present invention when the photoelectrochemical cell is in operation.

FIGS. 6A to 6C are cross-sectional views illustrating a photoelectrode production method of an embodiment 3 of the present invention.

FIG. 7 is a schematic diagram showing a configuration of an energy system of an embodiment 4 of the present invention.

FIG. 8 is a diagram showing an X-ray diffraction pattern of a Ta₃N₅/sapphire fabricated in an example.

FIG. 9 is a UV-vis transmission spectrum of the Ta₃N₅/sapphire fabricated in the example.

FIG. 10 is a diagram showing a photocurrent spectrum of a photoelectrode having a structure of Ta₃N₅/TiN/sapphire. FIG. 11 is a diagram showing photocurrent spectra of a photoelectrode having a structure of Ta₃N₅/ITO/glass and a photoelectrode having a structure of Ta₃N₅/ATO/sapphire.

### DESCRIPTION OF EMBODIMENTS

A photoelectrode is an electrode that can be used for generating hydrogen by water decomposition, and has a configuration in which a photocatalytic layer is supported on a conductive layer. For such a photoelectrode, the present inventors have found that the conventionally-proposed techniques described in “BACKGROUND ART” have the problems as described below.

For example, the production processes proposed in Non-Patent Literature 1 have a problem in that nitriding treatment using a flow of ammonia gas is difficult to carry out at an optimum temperature, and therefore a TaON photocatalytic film having high crystallinity and good necking cannot be obtained. This is because treating the FTO which is a conductive film at a high temperature (500° C. or higher) significantly increases the resistance value of the FTO itself, and thereby causes reduction in the activity of the resultant photoelectrode. A document (K. Onoda et al, Sol. Energy Mater. Sol. Cells 91 (2007) 1176-1181) has reported that in the case where the resistance value of FTO is, for example, 14.4 Ω/sq. at ordinary temperature, the resistance value is increased up to 66.7 Ω/sq. by annealing the FTO in air at 500° C. The temperature suitable for crystallization of TaON is 850 to 900° C., and nitriding treatment at 850 to 900° C. is suitable for improving the crystallinity and necking of TaON. Thus, there is a large difference in optimum production temperature between FTO and TaON. Therefore, when the processes described in Non-Patent Literature 1 are employed, it is very difficult to fabricate a photoelectrode in which a TaON photocatalytic film having high crystallinity and good necking is supported on a conductive film whose resistance value is low.

In addition, the production processes proposed in Non-Patent Literature 2 have a problem in that it is difficult to fabricate a photoelectrode while controlling the thickness of a Ta₃N₅ photocatalytic film. This is because a Ta oxide which is a precursor of Ta₃N₅ is formed by burning a Ta metal in air. Control of the thickness of the Ta oxide film fabricated by this method is very difficult since the thickness varies sharply depending on the burning conditions. Generally, the thickness of the photocatalytic film of the fabricated photoelectrode has an large influence on the activity of the photoelectrode. In view of the diffusion length of electrons and holes serving as carriers, the thickness of the photocatalytic film is set to several hundred nanometers to several micrometers in many cases. Thus, in order to obtain a photoelectrode that has high catalytic activity, control of the thickness of the photocatalytic film is highly important.

Taking the above into account, the present inventors have conducted a thorough study, and have finally succeeded in providing a photoelectrode that includes a conductive layer having a low resistance value and a photocatalytic layer having high catalytic activity and high crystallinity, and that can thus achieve high catalytic activity. Furthermore, the present inventors have also succeeded in providing a method for producing such a photoelectrode, a photoelectrochemical cell using the photoelectrode, an energy system using the photoelectrochemical cell, and a hydrogen generation method using the photoelectrochemical cell.

A first aspect of the present invention provides a photoelectrode including a conductive layer and a photocatalytic layer provided on the conductive layer. The conductive layer is made of a metal nitride, and the photocatalytic layer is made of at least one selected from the group consisting of a nitride semiconductor and an oxynitride semiconductor. When the photocatalytic layer is made of a n-type semiconductor, an energy difference between a vacuum level and a Fermi level of the conductive layer is smaller than an energy difference between the vacuum level and a Fermi level of the photocatalytic layer. When the photocatalytic layer is made of a p-type semiconductor, an energy difference between the vacuum level and a Fermi level of the conductive layer is larger than an energy difference between the vacuum level and a Fermi level of the photocatalytic layer.

In the photoelectrode according to the first aspect, the conductive layer is made of a metal nitride. Therefore, even when nitriding treatment needed to form the photocatalytic layer made of a nitride semiconductor and/or an oxynitride semiconductor on the conductive layer is carried out at an optimum temperature for the formation of the photocatalytic layer, the composition of the metal nitride of the conductive layer is not changed, and the resistance value of the conductive layer is not increased. On the contrary, since the nitriding treatment at the optimum temperature can increase the crystallinity of the conductive layer, the resistance value of the conductive layer can be made lower than before the nitriding treatment. The photoelectrode according to the first aspect can be constituted by both a conductive layer having a low resistance value and a photocatalytic layer having high catalytic activity and high crystallinity, and can exhibit high catalytic activity.

A second aspect of the present invention provides the photoelectrode as set forth in the first aspect, wherein the metal nitride may be a nitride containing at least one element selected from transition metal elements. The metal nitride has conductivity and is stable in an atmosphere (an ammonia gas flow atmosphere of 400 to 1000° C.) where a nitride semiconductor and/or an oxynitride semiconductor is synthesized. Therefore, the metal nitride is suitable as a material of the conductive layer.

A third aspect of the present invention provides the photoelectrode as set forth in the first aspect or the second aspect, wherein the nitride semiconductor may be a nitride containing a tantalum element, and the oxynitride semiconductor may be at least one selected from the group consisting of an oxynitride containing a tantalum element, an oxynitride containing a niobium element, and an oxynitride containing a titanium element. These materials function as a photocatalyst, and are therefore suitable as a material of the photocatalytic layer.

A fourth aspect of the present invention provides a photoelectrochemical cell including: the photoelectrode according to the first aspect, the second aspect, or the third aspect; a counter electrode electrically connected to the conductive layer included in the photoelectrode; and a container housing the photoelectrode and the counter electrode.

The photoelectrochemical cell according to the fourth aspect includes the photoelectrode according to the first aspect, the second aspect, or the third aspect. Therefore, efficient charge separation between electrons and holes generated by photoexcitation takes place, and thus light use efficiency can be improved.

A fifth aspect of the present invention provides the photoelectrochemical cell as set forth in the fourth aspect, wherein the photoelectrochemical cell may further include an electrolyte solution containing water, the electrolyte solution being housed in the container and being in contact with a surface of the photoelectrode and a surface of the counter electrode. With this configuration, a photoelectrochemical cell capable of generating hydrogen by water decomposition can be provided.

A sixth aspect of the present invention provides an energy system including: the photoelectrochemical cell according to the fifth aspect; a hydrogen storage connected to the photoelectrochemical cell by a first pipe and configured to store hydrogen generated in the photoelectrochemical cell; and a fuel cell connected to the hydrogen storage by a second pipe and configured to convert the hydrogen stored in the hydrogen storage into electricity.

The energy system according to the sixth aspect includes a photoelectrochemical cell using the photoelectrode according to the first aspect, the second aspect, or the third aspect. Therefore, light use efficiency can be improved.

A seventh aspect of the present invention provides a method for producing a photoelectrode having a conductive layer and a photocatalytic layer provided on the conductive layer, the method including the steps of: forming a metal nitride film serving as the conductive layer on a substrate; forming a metal oxide film on the metal nitride film; and subjecting the metal oxide film to nitriding treatment to form the photocatalytic layer.

With the method for producing a photoelectrode according to the seventh aspect, it is possible to form a photocatalytic layer having high catalytic activity and high crystallinity, while keeping the resistance value of the conductive layer low. Furthermore, control of the thickness of the photocatalytic layer is also easy. Therefore, with this production method, a photoelectrode exhibiting high catalytic activity can be produced.

An eighth aspect of the present invention provides the method for producing a photoelectrode as set forth in the seventh aspect, wherein the nitriding treatment may be performed by reacting the metal oxide film with ammonia gas. By using ammonia gas for nitriding treatment of the metal oxide film, a photocatalytic layer having high catalytic activity and high crystallinity can be formed more efficiently.

A ninth aspect of the present invention provides the method for producing a photoelectrode as set forth in the seventh aspect or the eighth aspect, wherein the method may further include a step of removing the substrate. By removing the substrate, a photoelectrode composed of a conductive layer and a photocatalytic layer and having no substrate can be produced.

A tenth aspect of the present invention provides the method for producing a photoelectrode as set forth in the seventh aspect, the eighth aspect, or the ninth aspect, wherein the metal oxide film may be at least one selected from the group consisting of a film of an oxide containing a tantalum element, a film of an oxide containing a niobium element, and a film of an oxide containing a titanium element. With this method, a photoelectrode including a photocatalytic layer made of a nitride or an oxynitride containing a tantalum element, a niobium element, and/or a titanium element, can be produced.

An eleventh aspect of the present invention provides a hydrogen generation method including the steps of: preparing the photoelectrochemical cell according to the fifth aspect; and irradiating the photocatalytic layer included in the photoelectrode with light.

The hydrogen generation method according to the eleventh aspect is a method for generating hydrogen by means of the photoelectrochemical cell using the photoelectrode according to the first aspect, the second aspect, or the third aspect. Therefore, light can be effectively used to achieve water decomposition and hydrogen generation with high quantum efficiency.

Hereinafter, embodiments of the present invention will be described in detail with reference to the drawings. The following embodiments are only examples, and the present invention is not limited to the following embodiments. In the following embodiments, the same components are denoted by the same reference numerals, and redundant descriptions are omitted in some cases.

### EMBODIMENT 1

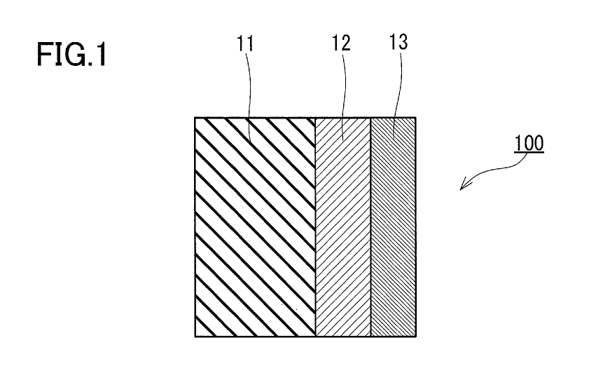

FIG. 1 shows an embodiment of a photoelectrode of the present invention. A photoelectrode 100 of the present embodiment includes a substrate 11, a conductive layer 12 provided on the substrate 11, and a photocatalytic layer 13 provided on the conductive layer 12.

For example, a glass substrate or a sapphire substrate can be used as the substrate 11. The substrate 11 is provided mainly for reasons of production (for example, one reason is that, in some cases, the substrate 11 is needed as a support for supporting the conductive layer 12 and the photocatalytic layer 13 during production). However, the substrate 11 need not be provided.

The conductive layer 12 is made of a metal nitride. The photocatalytic layer 13 is made of at least one selected from the group consisting of a nitride semiconductor and an oxynitride semiconductor.

Any metal nitride can be used for the conductive layer 12 as long as the metal nitride has conductivity and is stable in an atmosphere (ammonia gas flow atmosphere of 400 to 1000° C.) where a nitride semiconductor and/or an oxynitride semiconductor provided as the photocatalytic layer 13 on the conductive layer 12 is synthesized. Especially, a metal nitride containing at least one transition metal element can be used. For example, at least one selected from the group consisting of a nitride containing a titanium element (e.g., TiN), a nitride containing a zirconium element (e.g., ZrN), a nitride containing a niobium element (e.g., NbN), a nitride containing a tantalum element (e.g., TaN), a nitride containing a chromium element (e.g., Cr₂N), and a nitride containing a vanadium element (e.g., VN), can be used. Here, the element ratio between a metal element and a nitrogen element in the metal nitride is not particularly limited, and an alloy containing a plurality of metal elements can be used.

In the conductive layer 12, electrons move in a plane direction. Therefore, increase in the thickness of the conductive layer 12 results in reduction of the electric resistance of the conductive layer 12 because the cross-sectional area of the conductive layer 12 is increased by the increase in the thickness. That is, the resistance of the conductive layer 12 decreases with increase in its thickness. Meanwhile, increase in the thickness of the conductive layer 12 leads to increase in the influence of stress caused by the difference in lattice constant between the conductive layer 12 and the substrate 11 or the photocatalytic layer 13 supported on the conductive layer 12, with result that peeling or the like becomes more likely to occur. Accordingly, the thickness of the conductive layer 12 is desirably at least 10 nm in order to reduce its resistance. For practical use, the thickness of the conductive layer 12 is more desirably 50 to 150 nm in view of peeling and also of cost.

Any nitride semiconductor and any oxynitride semiconductor can be used for the photocatalytic layer 13 as long as the nitride semiconductor and the oxynitride semiconductor function as a photocatalyst. For example, a nitride containing a tantalum element (e.g., Ta₃N₅) can be used as the nitride semiconductor. For example, an oxynitride containing a tantalum element (e.g., TaON, BaTaO₂N), an oxynitride containing a niobium element (e.g., NbON, CaNbO₂N, SrNbO₂N), or an oxynitride containing a titanium element (e.g., LaTiO₂N), can be used as the oxynitride semiconductor.

The amount of light that can be absorbed by the photocatalytic layer 13 increases with increase in the thickness of the photocatalytic layer 13. Meanwhile, increase in the thickness of the photocatalytic layer 13 leads to a higher probability that electrons generated in the photocatalytic layer 13 recombine with holes before reaching the conductive layer 12. Accordingly, the thickness of the photocatalytic layer 13 is desirably at least 100 nm in order to absorb sufficient amount of light in the visible range, and is more desirably 100 nm to 20 μm from the standpoint of prevention of recombination between electrons and holes. The optimum thickness of the photocatalytic layer 13 depends also on the material used, the crystal defect, the surface morphology, and the like. Therefore, the thickness of the photocatalytic layer 13 is desirably determined as appropriate based on the semiconductor material used and the surface structure.

The portion of the conductive layer 12 that is not coated with the photocatalytic layer 13 is desirably coated, for example, with an insulating material such as a resin. With such a configuration, even in the case where, for example, the photoelectrode 100 is used in contact with an aqueous solution of an electrolyte (electrolyte solution), contact between the conductive layer 12 and the electrolyte solution can be prevented, and occurrence of leak current can be suppressed.

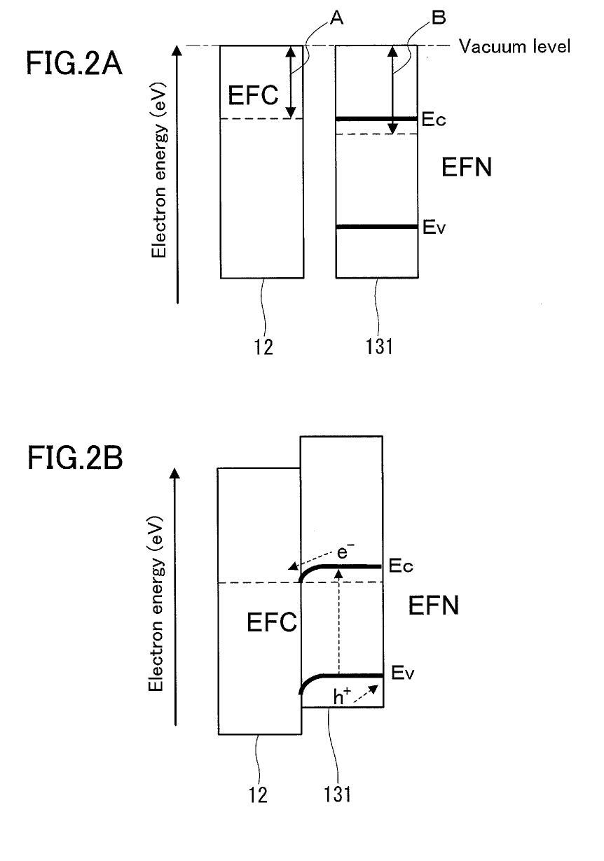

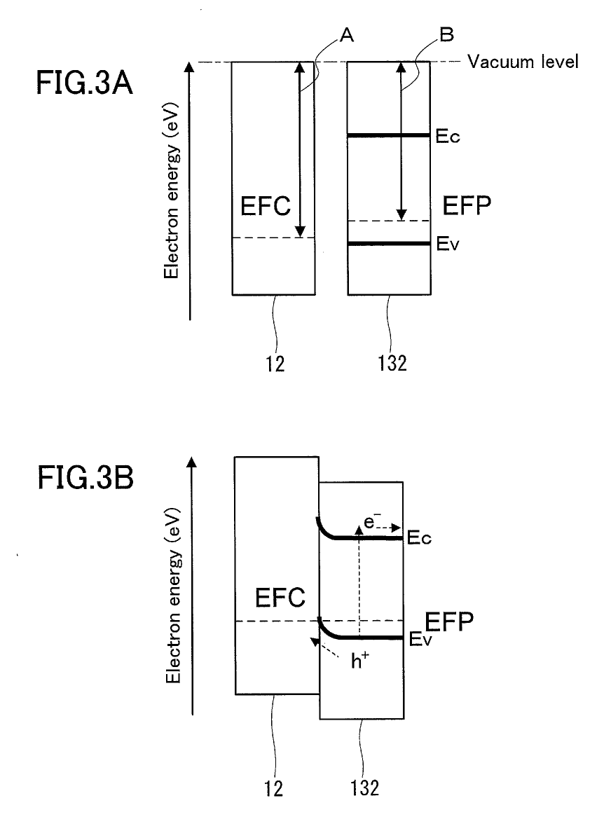

The metal nitride used for the conductive layer 12, and the nitride semiconductor and the oxynitride semiconductor used for the photocatalytic layer 13 are not particularly limited, and any of the aforementioned materials can be used. However, when the photocatalytic layer 13 is made of a n-type semiconductor, the combination of the metal nitride and the nitride semiconductor or the oxynitride semiconductor is desirably determined so that the energy difference between the vacuum level and the Fermi level of the conductive layer 12 is smaller than the energy difference between the vacuum level and the Fermi level of the photocatalytic layer 13. When the photocatalytic layer 13 is made of a p-type semiconductor, the combination of the metal nitride and the nitride semiconductor or the oxynitride semiconductor is desirably determined so that the energy difference between the vacuum level and the Fermi level of the conductive layer 12 is larger than the energy difference between the vacuum level and the Fermi level of the photocatalytic layer 13. Such combinations will be described with reference to FIGS. 2A and 2B and FIGS. 3A and 3B.

FIG. 2A is a schematic diagram showing a band structure observed before junction between the conductive layer 12 and a photocatalytic layer 131 made of a n-type semiconductor. FIG. 2B is a schematic diagram showing a band structure observed after junction between the conductive layer 12 and the photocatalytic layer 131 made of a n-type semiconductor. In FIGS. 2A and 2B, Ec denotes the lower edge of the conduction band of the n-type semiconductor, and Ev denotes the upper edge of the valence band of the n-type semiconductor.

As shown in FIG. 2A, when the layers have not been joined yet, an absolute value A of the energy difference between the vacuum level and the Fermi level (EFC) of the conductive layer 12 is smaller than an absolute value B of the energy difference between the vacuum level and the Fermi level (EFN) of the photocatalytic layer 131. In other words, when the vacuum level is regarded as a reference, the Fermi level (EFC) of the conductive layer 12 is higher than the Fermi level (EFN) of the photocatalytic layer 131. That is, EFC>EFN is satisfied. When the conductive layer 12 and the photocatalytic layer 131 are joined together, carriers move in the junction plane between the conductive layer 12 and the photocatalytic layer 131 so that the Fermi levels of the layers coincide with each other. As a result, band edge bending as shown in FIG. 2B is caused. At this time, no Schottky barrier is formed in the photocatalytic layer 131, and Ohmic contact is achieved between the conductive layer 12 and the photocatalytic layer 131. Therefore, electrons generated in the photocatalytic layer 131 move toward the conductive layer 12 without accumulating in the photocatalytic layer 131. Thus, efficiency of charge separation is significantly improved.

FIG. 3A is a schematic diagram showing a band structure observed before junction between the conductive layer 12 and a photocatalytic layer 132 made of a p-type semiconductor. FIG. 3B is a schematic diagram showing a band structure observed after junction between the conductive layer 12 and the photocatalytic layer 132 made of a p-type semiconductor. In FIGS. 3A and 3B, Ec denotes the lower edge of the conduction band of the p-type semiconductor, and Ev denotes the upper edge of the valence band of the p-type semiconductor.

As shown in FIG. 3A, when the layers have not been joined yet, an absolute value A of the energy difference between the vacuum level and the Fermi level (EFC) of the conductive layer 12 is larger than an absolute value B of the energy difference between the vacuum level and the Fermi level (EFP) of the photocatalytic layer 132. In other words, when the vacuum level is regarded as a reference, the Fermi level (EFC) of the conductive layer 12 is lower than the Fermi level (EFP) of the photocatalytic layer 132. That is, EFC<EFP is satisfied. When the conductive layer 12 and the photocatalytic layer 132 are joined together, carriers move in the junction plane between the conductive layer 12 and the photocatalytic layer 132 so that the Fermi levels of the layers coincide with each other. As a result, band edge bending as shown in FIG. 3B is caused. At this time, no Schottky barrier is formed in the photocatalytic layer 132, and Ohmic contact is achieved between the conductive layer 12 and the photocatalytic layer 132. Therefore, holes generated in the photocatalytic layer 132 move toward the conductive layer 12 without accumulating in the photocatalytic layer 132. Thus, efficiency of charge separation is significantly improved.

When it is attempted to form a photocatalytic layer made of a nitride semiconductor and/or an oxynitride semiconductor on a conductive layer as in the photoelectrode of the present embodiment, for example, a method is used in which an oxide serving as a precursor of the nitride semiconductor and/or the oxynitride semiconductor of the photocatalytic layer is formed in advance, and the oxide is then subjected to nitriding treatment. In the case of a conventional photoelectrode in which FTO is used as a conductive layer, if the nitriding treatment is carried out at an optimum temperature (e.g., 500° C. or higher) for formation of the photocatalytic layer, the resistance value of the conductive layer is significantly increased, leading to great reduction in the activity of the resultant photoelectrode. On the other hand, if the nitriding treatment is carried out at a low temperature in consideration of increase in the resistance value of the conductive layer, a photocatalytic layer having high catalytic activity cannot be obtained. By contrast, in the photoelectrode 100 of the present embodiment, the conductive layer 12 is made of a metal nitride. Therefore, even when the nitriding treatment is carried out at a high temperature to form the photocatalytic layer 13, the resistance value of the conductive layer 12 is not increased, but rather can be reduced by increase in the crystallinity of the conductive layer 12. Accordingly, the photoelectrode 100 of the present embodiment can be constituted by both the conductive layer 12 having a low resistance value and the photocatalytic layer 13 having high catalytic activity and high crystallinity, and can exhibit high catalytic activity.

### EMBODIMENT 2

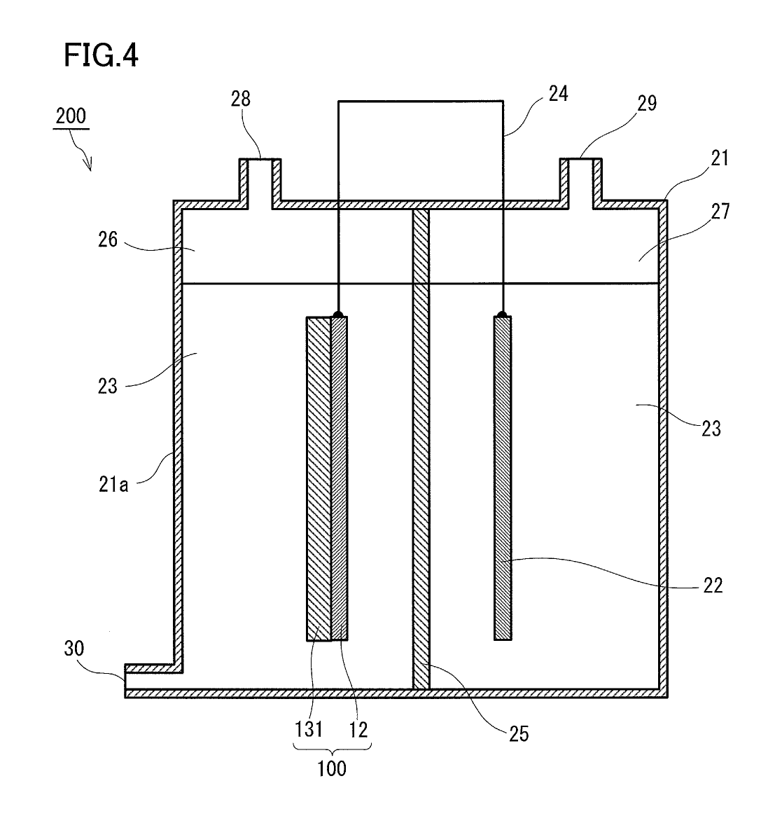

FIG. 4 shows a configuration of an embodiment of a photoelectrochemical cell of the present invention. As shown in FIG. 4, an electrochemical cell 200 of the present embodiment includes: a container 21; and a photoelectrode 100, a counter electrode 22, and a separator 25 which are housed in the container 21. The inside of the container 21 is separated by the separator 25 into two chambers, a first chamber 26 and a second chamber 27. An electrolyte solution 23 containing water is housed in each of the first chamber 26 housing the photoelectrode 100 and the second chamber 27 housing the counter electrode 22. The separator 25 need not be provided.

In the first chamber 26, the photoelectrode 100 is disposed in contact with the electrolyte solution 23. The photoelectrode 100 includes the conductive layer 12 and the photocatalytic layer 131 provided on the conductive layer 12 and made of a n-type semiconductor. The conductive layer 12 and the photocatalytic layer 131 are as described in the embodiment 1. In the present embodiment, the photoelectrode 100 has a configuration in which the substrate 11 is not provided.

The first chamber 26 includes a first discharge outlet 28 for discharging oxygen generated in the first chamber 26, and a feed water inlet 30 for feeding water into the first chamber 26. The portion (hereinafter, abbreviated as a light incident portion 21a) of the container 21 that faces the photocatalytic layer 131 of the photoelectrode 100 disposed in the first chamber 26 is made of a material that allows transmission of light such as sunlight. For example, Pyrex (registered trademark) glass or an acrylic resin can be used as the material of the container 21.

On the other hand, in the second chamber 27, the counter electrode 22 is disposed in contact with the electrolyte solution 23. In addition, the second chamber 27 includes a second discharge outlet 29 for discharging hydrogen generated in the second chamber 27.

The conductive layer 12 of the photoelectrode 100 and the counter electrode 22 are electrically connected by a conducting wire 24.

The conductive layer 12 and the photocatalytic layer 131 of the photoelectrode 100 of the present embodiment have the same configurations as the conductive layer 12 and the photocatalytic layer 131 of the photoelectrode 100 of the embodiment 1, respectively. Therefore, the photoelectrode 100 provides the same effect as the photoelectrode 100 of the embodiment 1.

Here, the counter electrode means an electrode that exchanges electrons with the photoelectrode without the mediation of the electrolyte solution. Accordingly, the counter electrode 22 of the present embodiment only needs to be electrically connected to the conductive layer 12 of the photoelectrode 100, and, for example, the positional relationship of the counter electrode 22 with the photoelectrode 100 is not particularly limited.

The electrolyte solution 23 only needs to be an electrolyte solution containing water, and may be either acidic or alkaline. Water may be used as the electrolyte solution 23. In addition, the electrolyte solution 23 may be constantly injected into the container 21, or may be injected into the container 21 only when the photoelectrochemical cell 200 is in use.

The separator 25 is formed of a material that has the function of allowing transmission of the electrolyte solution 23 and blocking gases generated in the first chamber 26 and the second chamber 27. Examples of the material of the separator 25 include solid electrolytes such as polymer solid electrolytes. Examples of polymer solid electrolytes include ion-exchange membranes such as Nafion (registered trademark). The internal space of the container is divided by such a separator into two regions, in one of which the electrolyte solution 23 and the surface (the photocatalytic layer 131) of the photoelectrode 100 are brought into contact with each other, and in the other of which the electrolyte solution 23 and the surface of the counter electrode 22 are brought into contact with each other. With such a configuration, oxygen and hydrogen generated in the container 21 can easily be separated.

The conducting wire 24 electrically connects the counter electrode 22 to the conductive layer 12, and allows transfer of electrons or holes generated in the photoelectrode 100 without application of electric potential from outside. In the present embodiment, since a metal nitride is used as the conductive layer 12, the Ohmic junction between the metal nitride and the conducting wire 24 is excellent.

Next, the operation of the photoelectrochemical cell 200 of the present embodiment will be described. Here, the operation will be described on the assumption that the Fermi levels of the conductive layer 12 and the photocatalytic layer 131 of the photoelectrode 100 satisfy the relationships shown in FIGS. 2A and 2B.

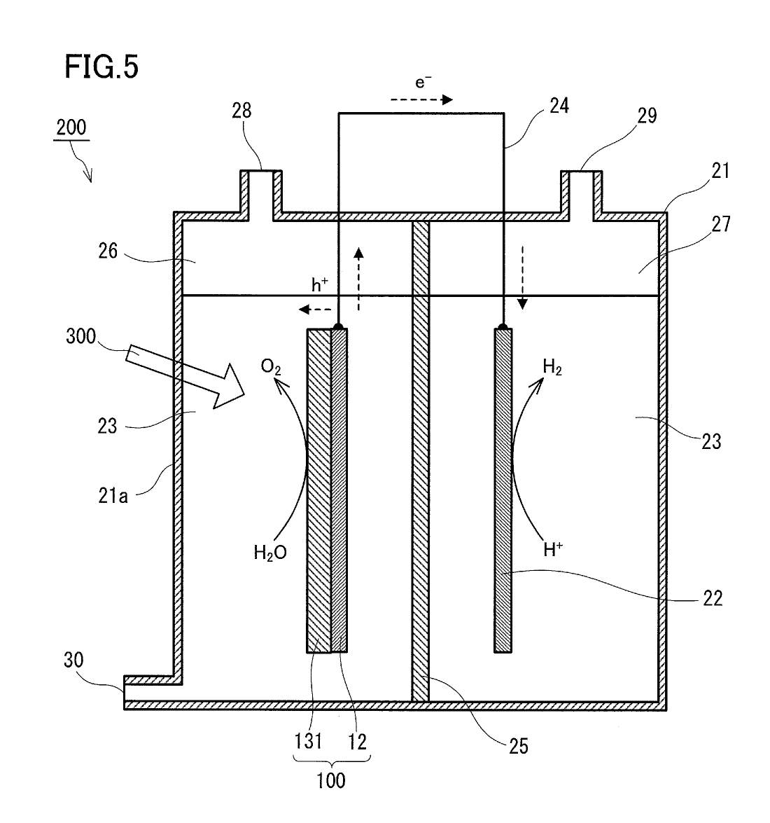

As shown in FIG. 5, the photocatalytic layer 131 of the photoelectrode 100 disposed in the container 21 is irradiated with light 300 (e.g., sunlight) incident through the light incident portion 21a of the container 21 of the photoelectrochemical cell 200. As a result, in the portion of the photocatalytic layer 131 that has been irradiated with the light, electrons are generated in the conduction band, and holes are generated in the valence band. The holes generated at this time move to the vicinity of the surface of the photocatalytic layer 131. Consequently, water is decomposed at the surface of the photocatalytic layer 131 according to the following reaction formula (1), and thus oxygen is generated. On the other hand, the electrons move to the conductive layer 12 along the band edge bending of the conduction band in the photocatalytic layer 131. The electrons having reached the conductive layer 12 move toward the counter electrode 22 electrically connected to the conductive layer 12 via the conducting wire 24. Consequently, hydrogen is generated at the surface of the counter electrode 22 according to the following reaction formula (2). Since the n-type semiconductor of the photocatalytic layer 131 has high crystallinity, the resistance of the photocatalytic layer 131 is low. Therefore, the electrons can move in the photocatalytic layer 131 to a region in the vicinity of the junction plane between the photocatalytic layer 131 and the conductive layer 12 without being obstructed. Furthermore, since no or only a very low Schottky barrier is formed at the junction plane between the photocatalytic layer 131 and the conductive layer 12, the electrons can move to the conductive layer 12 without being obstructed. Accordingly, the probability of recombination between electrons and holes generated by photoexcitation in the photocatalytic layer 131 is reduced, and the quantum efficiency of the hydrogen generation reaction induced by irradiation with light is improved.

4h⁺+2H₂O→O₂↑+4H+ (reaction formula 1)

4e⁻+4H+→2H₂↑ (reaction formula 2)

In the photoelectrochemical cell 200 of the present embodiment, the photocatalytic layer 131 made of a n-type semiconductor is used in the photoelectrode 100. However, the photocatalytic layer 132 made of a p-type semiconductor (see FIGS. 3A and 3B) may be used. In the description of the operation of the photoelectrochemical cell 200 for which the photocatalytic layer 132 made of a p-type semiconductor is used, the flows of electrons and holes, and the electrodes for generating hydrogen and oxygen, are reversed from those in the case of a n-type semiconductor. That is, hydrogen is generated at the photoelectrode 100 side, and oxygen is generated at the counter electrode 22 side.

### EMBODIMENT 3

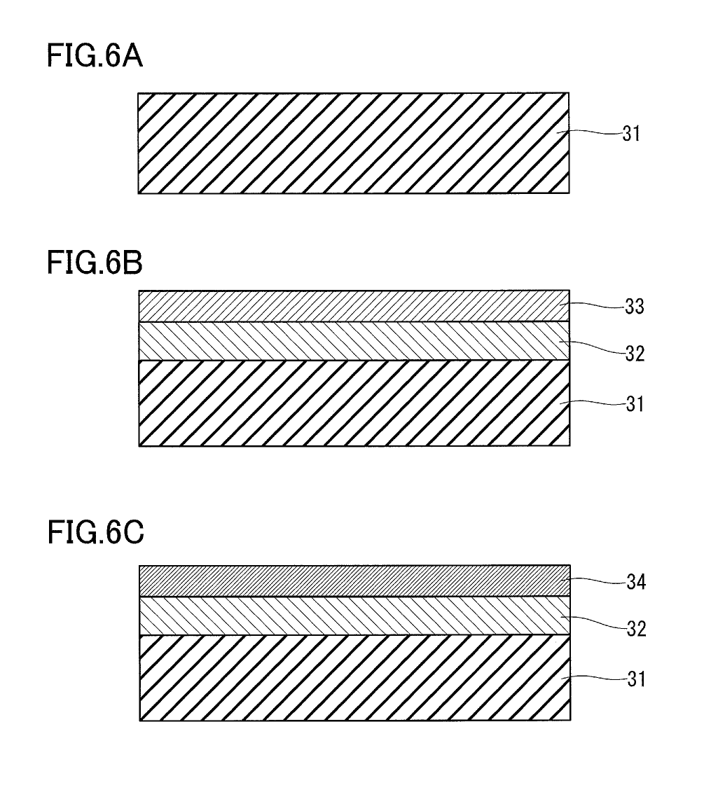

A photoelectrode production method of the present invention will be described. FIGS. 6A to 6C are cross-sectional views illustrating the steps of the photoelectrode production method of the present embodiment. The production method of the present embodiment is a method for producing a photoelectrode that includes a conductive layer and a photocatalytic layer provided on the conductive layer.

First, a metal nitride film 32 serving as the conductive layer is formed on a substrate 31 (FIG. 6A) serving as a support, and a metal oxide film 33 is then formed on the metal nitride film 32 (FIG. 6B).

The metal nitride film 32 is formed on the substrate 31. The metal nitride film 32 is a film serving as the conductive layer of the photoelectrode (the conductive layer 12 of the photoelectrode 100 of the embodiment 1 (see FIG. 1)). Specific examples of the material of the metal nitride film 32 include a nitride containing a titanium element (e.g., TiN), a nitride containing a zirconium element (e.g., ZrN), a nitride containing a niobium element (e.g., NbN), a nitride containing a tantalum element (e.g., TaN), a nitride containing a chromium element (e.g., Cr₂N), and a nitride containing a vanadium element (e.g., VN). The thickness of the metal nitride film 32 is determined in consideration of the desired thickness of the conductive layer of the photoelectrode to be produced. For example, the thickness of the metal nitride film 32 is desirably 10 nm or more, and more desirably 50 nm to 150 nm. Any of various methods such as sputtering, vapor deposition, and spin coating, can be used for forming the metal nitride film 32. That is, the film formation method is not particularly limited.

The metal oxide film 33 is provided on the metal nitride film 32. The metal oxide film 33 is a film to be converted into the photocatalytic layer of the photoelectrode (the photocatalytic layer 13 of the photoelectrode 100 of the embodiment 1 (see FIG. 1)) through the subsequent nitriding treatment step. Specific examples of the metal oxide film 33 include a film of an oxide containing a tantalum element (e.g., Ta₂O₅), a film of an oxide containing a niobium element (e.g., Nb₂O₅), and a film of an oxide containing a titanium element. The thickness of the metal oxide film 33 is determined in consideration of the desired thickness of the photocatalytic layer of the photoelectrode to be produced. For example, the thickness of the metal oxide film 33 is desirably 100 nm or more, and more desirably 100 nm to 20 μm. Any of various methods such as sputtering, vapor deposition, and spin coating, can be used for forming the metal oxide film 33. That is, the film formation method is not particularly limited.

Next, the metal oxide film 33 is subjected to nitriding treatment. A film 34 made of a nitride semiconductor and/or an oxynitride semiconductor and serving as the photocatalytic layer of the photoelectrode is formed by the nitriding treatment (FIG. 6C). The material of the film 34 to be obtained is determined based on the metal element contained in the metal oxide film 33. An oxynitride semiconductor suitable as the material of the film 34, and therefore of the photocatalytic layer, is an oxynitride containing a tantalum element (e.g., TaON, BaTaO₂N), an oxynitride containing a niobium element (e.g., NbON, CaNbO₂N, SrNbO₂N), or an oxynitride containing a titanium element (e.g., LaTiO₂N). A nitride semiconductor that can be used is, for example, a nitride containing a tantalum element (e.g., Ta₃N₅).

The specific steps of the nitriding treatment are as follows. A multilayer body in which the metal nitride film 32 and the metal oxide film 33 are provided on the substrate 31 is set in a furnace. Next, nitrogen gas is allowed to flow through the furnace, and the temperature in the furnace is increased from a room temperature to 800 to 1000° C. at a temperature increase rate of 80 to 120° C./hour. Thereafter, the flowing gas is switched to ammonia gas, the temperature in the furnace is maintained at 800 to 1000° C. for about 6 to 10 hours, and is then decreased at a temperature decrease rate of 80 to 120° C./hour. Furthermore, when the temperature has reached a temperature at which the obtained film made of a nitride semiconductor and/or an oxynitride semiconductor cannot be oxidized by oxygen contained in nitrogen gas, the flowing gas is switched from ammonia gas to nitrogen gas.

The substrate 31 is used as a support for supporting the films during production. Therefore, the step of removing the substrate 31 may be performed after the films 32 and 34 respectively serving as the conductive layer and the photocatalytic layer have been formed. In this case, the substrate 31 can be removed, for example, by lapping or selective etching. As a matter of course, the substrate 31 may be kept as a component of the photoelectrode. In this case, the substrate 31 corresponds to the substrate 11 of the photoelectrode 100 described in the embodiment 1 (see FIG. 1).

If the metal nitride film is exposed to air, there is a risk that surface states are formed in the surface of the metal nitride film, and pinning of the Fermi level is thus caused. Accordingly, the formation of the metal nitride film 32 and the formation of the metal oxide film 33 are desirably performed continuously in a vacuum apparatus.

According to the production method of the present embodiment, a metal nitride film is used as a conductive layer. Therefore, as described in the embodiment 1, it is possible to form a conductive layer whose resistance value is prevented from increasing. In addition, according to the production method of the present embodiment, not only a conductive layer having a low resistance value but also a photocatalytic layer having high catalytic activity and high crystallinity can be formed. Furthermore, in the production method of the present embodiment, a metal oxide film having a desired thickness is formed on a metal nitride film first, and the metal oxide film is subjected to nitriding treatment to form a photocatalytic layer. Therefore, control of the thickness of the photocatalytic layer is easy. Thus, according to the production method of the present embodiment, the photoelectrode of the present invention that exhibits high catalytic activity can be produced.

### EMBODIMENT 4

An embodiment of an energy system of the present invention will be described.

The energy system of the present embodiment includes: a photoelectrochemical cell; a hydrogen storage connected to the photoelectrochemical cell by a first pipe and configured to store hydrogen generated in the photoelectrochemical cell; and a fuel cell connected to the hydrogen storage by a second pipe and configured to convert hydrogen stored in the hydrogen storage into electricity. The photoelectrochemical cell is a cell as described in the embodiment 2, and includes: the photoelectrode of the present invention; a counter electrode electrically connected to the conductive layer included in the photoelectrode; an electrolyte solution containing water and being in contact with a surface of the photoelectrode and a surface of the counter electrode; and a container housing the photoelectrode, the counter electrode, and the electrolyte solution. With this configuration, it is possible to built a highly efficient system from which electricity can be obtained as necessary. The energy system of the present embodiment may further include a storage battery configured to store the electricity resulting from conversion by the fuel cell.

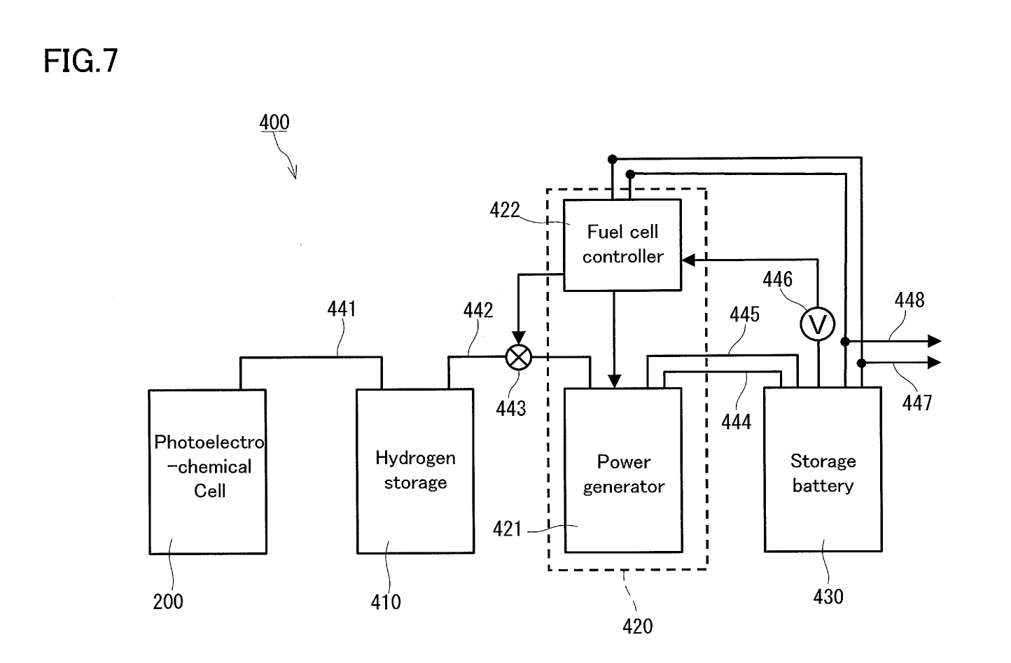

Next, an energy system 400 of the present embodiment will be described with reference to FIG. 4, FIG. 5, and FIG. 7.

The energy system 400 of the present embodiment includes a photoelectrochemical cell 200, a hydrogen storage 410, a fuel cell 420, and a storage battery 430. In the present embodiment, a description will be given of an example where the photoelectrochemical cell 200 described in the embodiment 2 is used.

The photoelectrochemical cell 200 is the photoelectrochemical cell described in the embodiment 2, and its specific configuration is as shown in FIG. 4 and FIG. 5. Therefore, a detailed description of the photoelectrochemical cell 200 is omitted.

The hydrogen storage 410 is connected to the second chamber 27 (see FIG. 4 and FIG. 5) of the photoelectrochemical cell 200 by a first pipe 441. For example, the hydrogen storage 410 can be composed of a compressor configured to compress hydrogen generated in the photoelectrochemical cell 200, and a high-pressure hydrogen tank configured to store the hydrogen compressed by the compressor.

The fuel cell 420 includes a power generator 421 and a fuel cell controller 422 for controlling the power generator 421. The fuel cell 420 is connected to the hydrogen storage 410 by a second pipe 442. The second pipe 442 is provided with a shut-off valve 443. For example, a fuel cell of polymer solid electrolyte type can be used as the fuel cell 420.

The positive electrode and the negative electrode of the storage battery 430 are electrically connected to the positive electrode and the negative electrode of the power generator 421 of the fuel cell 420 by a first line 444 and a second line 445, respectively. The storage battery 430 is provided with a capacity meter 446 for measuring the remaining capacity of the storage battery 430. For example, a lithium-ion battery can be used as the storage battery 430.

Next, the operation of the energy system 400 of the present embodiment will be described. Here, the operation will be described on the assumption that the Fermi levels of the conductive layer 12 and the photocatalytic layer 131 of the photoelectrode 100 satisfy the relationships shown FIGS. 2A and 2B.

When the surface of the photocatalytic layer 131 of the photoelectrode 100 disposed in the first chamber 26 is irradiated with sunlight incident through the light incident portion 21a of the photoelectrochemical cell 200, electrons and holes are generated in the photocatalytic layer 131. The holes generated at this time move toward the surface of the photocatalytic layer 131. Consequently, water is decomposed at the surface of the photocatalytic layer 131 according to the above reaction formula (1), and thus oxygen is generated.

On the other hand, the electrons move to the conductive layer 12 along the band edge bending of the conduction band in the photocatalytic layer 131. The electrons having reached the conductive layer 12 move toward the counter electrode 22 electrically connected to the conductive layer 12 via the conducting wire 24. Consequently, hydrogen is generated at the surface of the counter electrode 22 according to the above reaction formula (2).

In this case, since the n-type semiconductor of the photocatalytic layer 131 has high crystallinity, the resistance of the photocatalytic layer 131 is low. Therefore, the electrons can move in the photocatalytic layer 131 to a region in the vicinity of the junction plane between the photocatalytic layer 131 and the conductive layer 12 without being obstructed. Furthermore, since no or only a very low Schottky barrier is formed at the junction plane between the photocatalytic layer 131 and the conductive layer 12, the electrons can move to the conductive layer 12 without being obstructed. Accordingly, the probability of recombination between electrons and holes generated by photoexcitation in the photocatalytic layer 131 is reduced, and the quantum efficiency of the hydrogen generation reaction induced by irradiation with light can be improved.

The oxygen generated in the first chamber 26 is discharged from the first discharge outlet 28 to the outside of the photoelectrochemical cell 200. On the other hand, the hydrogen generated in the second chamber 27 is supplied into the hydrogen storage 410 via the second discharge outlet 29 and the first pipe 441.

In power generation in the fuel cell 420, the shut-off valve 443 is opened in response to a signal from the fuel cell controller 422, and hydrogen stored in the hydrogen storage 410 is supplied to the power generator 421 of the fuel cell 420 through the second pipe 442.

The electricity generated in the power generator 421 of the fuel cell 420 is stored in the storage battery 430 by being transmitted via the first line 444 and the second line 445. The electricity stored in the storage battery 430 is supplied to houses, companies, and the like, through a third line 447 and a fourth line 448.

With the photoelectrochemical cell 200 of the present embodiment, the quantum efficiency of hydrogen generation reaction induced by irradiation with light can be improved. Therefore, with the energy system 400 of the present embodiment that includes such a photoelectrochemical cell 200, electricity can be supplied efficiently.

In the present embodiment, an example of an energy system using the photoelectrochemical cell 200 described in the embodiment 2 has been described.

However, for example, a photoelectrochemical cell using a p-type semiconductor for the photocatalytic layer of the photoelectrode 100, or a photoelectrochemical cell not provided with the separator 25 (in the case of which hydrogen is collected in the form of a mixed gas containing oxygen, and hydrogen is separated from the mixed gas as necessary), can also be used.

### EXAMPLES

### Example

Hereinafter, an example of the photoelectrode of the present invention will be described. Here, as an example of the photoelectrode of the present invention, a photoelectrode was produced in which a TiN film is provided as a conductive layer on a sapphire substrate, and a Ta₃N₅ film is provided as a photocatalytic layer. Furthermore, the film serving as the photocatalytic layer of the photoelectrode was evaluated.

(Method for Producing Photoelectrode)

A TiN film was formed on a sapphire substrate by reactive sputtering. The reactive sputtering was carried out using a Ti metal as a target under the conditions that the amount of argon supplied to a chamber was 1.52×10⁻³ Pa·m³/s (9.0 sccm), the amount of nitrogen supplied was 1.69×10⁻⁴ Pa·m³/s (1.0 sccm), and the total pressure was 0.3 Pa. Next, a Ta₂O₅ film was formed on the TiN film by carrying out reactive sputtering using a Ta metal as a target under the conditions that the amount of argon supplied was 4.24×10⁻³ Pa·m³/s (25 sccm), the amount of oxygen supplied was 8.45×10⁻⁴ Pa·m³/s (5 sccm), and the total pressure was 2.7 Pa. In this manner, a multilayer body of Ta₂O₅/TiN/sapphire was formed. Next, the multilayer body was placed on an alumina substrate, and was set in a furnace. While nitrogen gas was allowed to flow through the furnace, the temperature in the furnace was increased from a room temperature to 900° C. at a temperature increase rate of 100° C./hour. Thereafter, the flowing gas was switched to ammonia gas, and the temperature in the furnace was maintained at 900° C. for 8 hours. Thereafter, the temperature in the furnace was decreased at a temperature decrease rate of 100° C./hour, with result that an intended multilayer body of Ta₃N₅/TiN/sapphire was obtained. When the temperature decreased to 450° C., the flowing gas was switched again from ammonia gas to nitrogen gas. The thickness of the Ta₃N₅ film was 200 nm, and the thickness of the TiN film was 100 nm.

(XRD Structural Analysis of Ta₃N₅ Film)

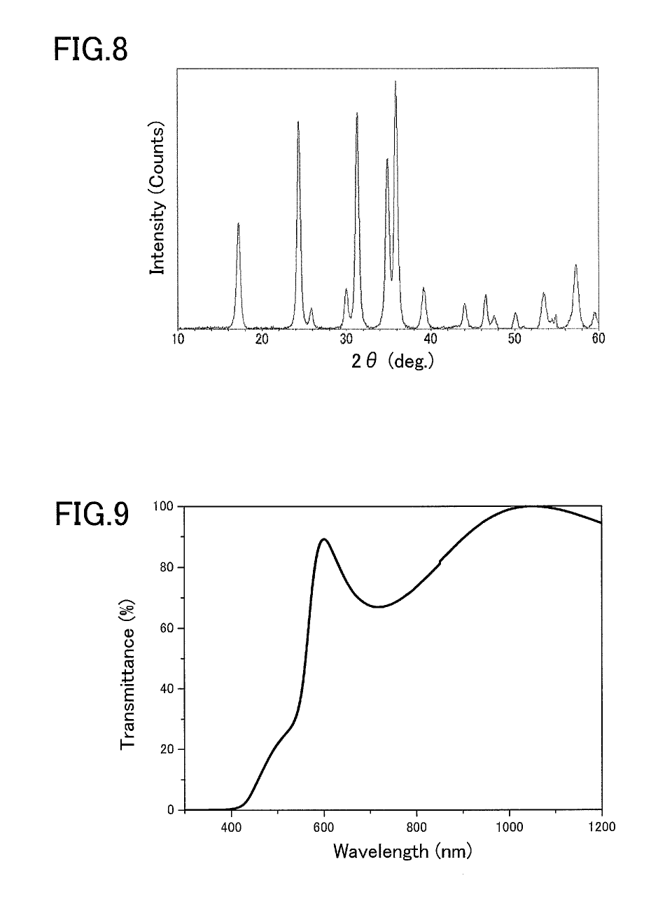

The Ta₃N₅ film serving as the photocatalytic layer of the photoelectrode of the present example was subjected to XRD structural analysis. A Ta₃N₅/sapphire was used as a measurement sample for the XRD structural analysis. The Ta₃N₅/sapphire was obtained as follows: a Ta₂O₅ film was formed on a sapphire substrate by carrying out sputtering under the same conditions as those in the above photoelectrode production method, and then the Ta₂O₅ film was subjected to nitriding treatment. The X-ray diffraction pattern of the Ta₃N₅ thin film is shown in FIG. 8. In the pattern shown in FIG. 8, all of the peaks are attributable to Ta₃N₅, and peaks derived from Ta₂O₅ are not observed. From this fact, it is confirmed that a single-phase Ta₃N₅ was formed in the present example.

(UV-vis Transmission Spectrum)

Using the measurement sample (Ta₃N₅/sapphire) for which formation of a single-phase Ta₃N₅ was confirmed by the XRD structural analysis, a UV-vis transmission spectrum was measured with a spectrophotometer. The result is shown in FIG. 9. Using the obtained transmission spectrum, the band gap of Ta₃N₅ was calculated from the absorption edge wavelength according to the following mathematical formula (1). In the UV-vis transmission spectrum of the Ta₃N₅/sapphire substrate, absorption edge was confirmed at around 600 nm. The band gap estimated from this value was about 2.1 eV. This result was confirmed as being consistent with literature data of the band gap of Ta₃N₅ (Ishikawa et al, J. Phys. Chem. B2004, 108, 11049-11053). It may appear that absorption at 600 nm or more can also be observed in the spectrum shown in FIG. 9, but this is due to influence of interference caused at the time of measurement.

Band gap [eV]=1240/absorption edge wavelength [eV] . . . (mathematical formula 1)

(Photocurrent Measurement)

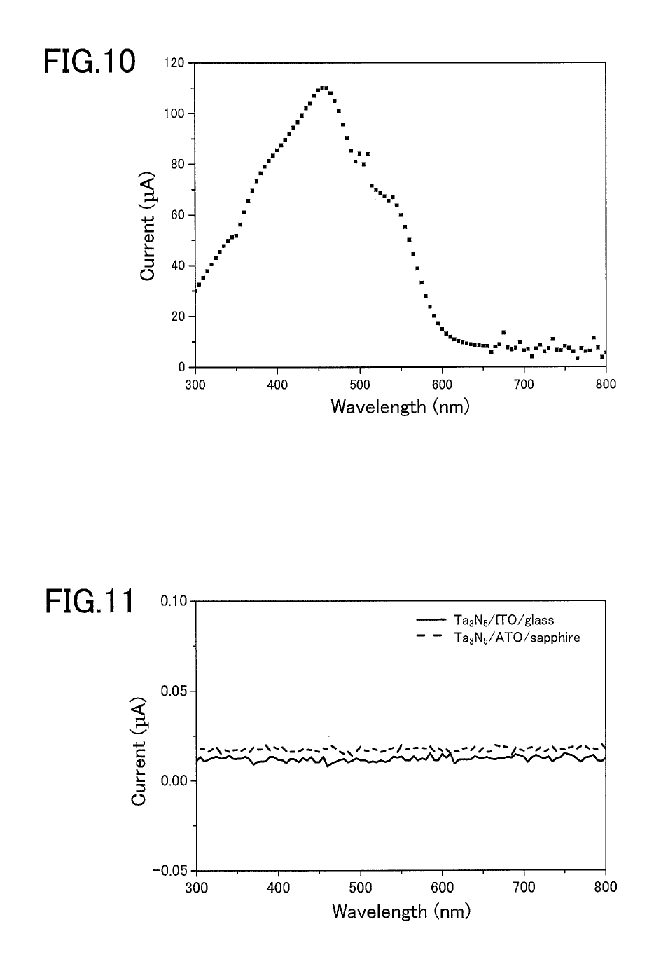

Photocurrents were measured using the photoelectrode fabricated in the present example. White light emitted from a Xe lamp serving as a light source was monochromatized with a spectroscope, and the photoelectrode of the present example set in a photoelectrochemical cell was irradiated with the monochromatized light. Photocurrents generated at this time were measured for various wavelengths. The photocurrent measurement result is shown in FIG. 10. The photoelectrochemical cell used in this measurement had the same configuration as the photoelectrochemical cell 200 described in the embodiment 2 and shown in FIG. 4. A 1 mol/L NaOH aqueous solution was used as the electrolyte solution. A platinum sheet was used as the counter electrode. The conductive layer (TiN film) of the photoelectrode and the counter electrode were electrically connected by a conducting wire. The photocurrents were obtained at wavelengths of 600 nm or less. Rise of current was observed at around the same wavelength as the absorption edge wavelength in the UV-vis transmission spectrum.

### Comparative Example

A photoelectrode whose conductive layer was made of ATO (Antimony Tin Oxide) and a photoelectrode whose conductive layer was made of ITO (Indium Tin Oxide) were fabricated as comparative examples. Under the same conditions as those in the above example, a Ta₂O₅ film was formed by sputtering on each of a substrate (ATO/sapphire) in which ATO was provided on a sapphire substrate and a substrate (ITO/glass) in which ITO was provided on a glass substrate. Furthermore, the Ta₂O₅ films were subjected to nitriding treatment under the same conditions as those in the above example, with the result that a photoelectrode including a multilayer body of Ta₃N₅/ATO/sapphire and a photoelectrode including a multilayer body of Ta₃N₅/ITO/glass were obtained. Photocurrent measurement was carried out for these photoelectrodes in the same manner as in the above example. The results are shown in FIG. 11.

In the case where a Ta₂O₅ film was formed on ATO by sputtering, and then was nitrided in a flow of ammonia gas (nitriding treatment temperature: 900° C.), the ATO portion did not have conductivity, although the appearance of the ATO portion did not change very much. In addition, peeling of the obtained Ta₃N₅ film from the ATO/sapphire portion was observed. For these reasons, no photocurrent was observed.

In the case where a Ta₂O₅ film was formed on ITO by sputtering, and then was nitrided in a flow of ammonia gas (nitriding treatment temperature: 900° C.), the ITO/glass portion was colored black, and did not have conductivity. In addition, a large portion of the obtained Ta₃N₅ film was peeled from the ITO/glass portion. For these reasons, no photocurrent was observed.

### INDUSTRIAL APPLICABILITY

With the photoelectrode, the photoelectrochemical cell, and the energy system of the present invention, the quantum efficiency of hydrogen generation reaction induced by irradiation with light can be improved. Therefore, the photoelectrode, the photoelectrochemical cell, and the energy system of the present invention are industrially useful for energy systems such as devices for generating hydrogen by water decomposition.

1. A photoelectrode comprising a conductive layer and a photocatalytic layer provided on the conductive layer, wherein
the conductive layer is made of a metal nitride,
the photocatalytic layer is made of at least one selected from the group consisting of a nitride semiconductor and an oxynitride semiconductor,
an energy difference between a vacuum level and a Fermi level of the conductive layer is smaller than an energy difference between the vacuum level and a Fermi level of the photocatalytic layer when the photocatalytic layer is made of a n-type semiconductor,
an energy difference between the vacuum level and a Fermi level of the conductive layer is larger than an energy difference between the vacuum level and a Fermi level of the photocatalytic layer when the photocatalytic layer is made of a p-type semiconductor, and
the metal nitride is a nitride containing at least one element selected from transition metal elements.

2. (canceled)

3. The photoelectrode according to claim 1, wherein
the nitride semiconductor is a nitride containing a tantalum element, and
the oxynitride semiconductor is at least one selected from the group consisting of an oxynitride containing a tantalum element, an oxynitride containing a niobium element, and an oxynitride containing a titanium element.

4. A photoelectrochemical cell comprising:
the photoelectrode according to claim 1;
a counter electrode electrically connected to the conductive layer included in the photoelectrode; and
a container housing the photoelectrode and the counter electrode.

5. The photoelectrochemical cell according to claim 4, further comprising an electrolyte solution containing water, the electrolyte solution being housed in the container and being in contact with a surface of the photoelectrode and a surface of the counter electrode.

6. An energy system comprising:
the photoelectrochemical cell according to claim 5;
a hydrogen storage connected to the photoelectrochemical cell by a first pipe and configured to store hydrogen generated in the photoelectrochemical cell; and
a fuel cell connected to the hydrogen storage by a second pipe and configured to convert the hydrogen stored in the hydrogen storage into electricity.

7. A method for producing a photoelectrode having a conductive layer and a photocatalytic layer provided on the conductive layer, the method comprising the steps of:
forming a metal nitride film serving as the conductive layer on a substrate;
forming a metal oxide film on the metal nitride film; and
subjecting the metal oxide film to nitriding treatment to form the photocatalytic layer.

8. The method for producing a photoelectrode according to claim 7, wherein the nitriding treatment is performed by reacting the metal oxide film with ammonia gas.

9. The method for producing a photoelectrode according to claim 7, further comprising a step of removing the substrate.

10. The method for producing a photoelectrode according to claim 7, wherein the metal oxide film is at least one selected from the group consisting of a film of an oxide containing a tantalum element, a film of an oxide containing a niobium element, and a film of an oxide containing a titanium element.

11. A hydrogen generation method comprising the steps of:
preparing the photoelectrochemical cell according to claim 5; and
irradiating the photocatalytic layer included in the photoelectrode with light.
